(19) United States
(12) Patent Application Publication
(10) Pub. No.: US 2015/0006248 A1
(43) Pub. Date: Jan. 1, 2015

(54) SYSTEM AND METHOD TO DETERMINE A COMPANY ACCOUNT INTEREST SCORE OR SALES LEAD INTEREST SCORE

(71) Applicant: Linkedln Corporated, Mountain View, CA (US)

(72) Inventors: Yue Li, San Jose, CA (US); Saad Hameed, Fremont, CA (US); Nicolas Draca, Los Gatos, CA (US); Vibhu Prakash Saxena, San Jose, CA (US)

(21) Appl. No.: 13/934,002

(22) Filed: Jul. 2, 2013

Related U.S. Application Data
(60) Provisional application No. 61/841,078, filed on Jun. 28, 2013.

(51) Int. Cl. G06Q 10/06; G06Q 30/02

(52) U.S. Cl. CPC G06Q 10/06395; G06Q 30/0202
USPC 705/7.31

(57) ABSTRACT

Techniques for determining the likelihood of a sales lead to purchase a product or service based on an interest score of a company account generated using individual interest scores of the members of the company account are described. For example, a first individual interest score of a first user for a product or service and a second individual interest score of a second user for the product or service are received. Using account data that identifies members of a company account, a determination is made that the first user and the second user are members of the same company account. An account interest score of the company account for the product or service is generated, using at least one computer processor, based on combining the first individual interest score and the second individual interest score.

### TECHNICAL FIELD

The present disclosure generally relates to data processing systems. More specifically, the present disclosure relates to methods, systems, and computer program products for deriving an interest score representing a measure of likelihood that an organization will purchase a product or service.

### BACKGROUND

Traditionally, in an attempt to sell a product or a service, a salesperson will contact one or more people in a list of “leads” (e.g., potential purchasers) and make one or more sales pitches. The success of any business organization depends largely on the effectiveness of the organization's sales team. A business organization with excellent manufacturing operations, cutting-edge technology, tight financial goals, and progressive management techniques will still struggle if it lacks an effective sales mechanism. At least one aspect that impacts the overall effectiveness of a sales team is the sales team's ability to accurately identify and timely engage sales leads—persons having an interest and authority to purchase a product or service, or persons who can facilitate connections between salespeople and potential buyers.

Traditionally, sales leads may be identified in a number of ways, to include trade shows, direct marketing, advertising, Internet marketing, spam, gimmicks, or sales person prospecting activities such as cold calling. A sales lead may represent a new company account, for instance, when the person is considering the purchase of a product or service for the first time. Alternatively, a sales lead may represent an existing company account, such as when an individual may become a repeat buyer of a product or service. Typically, a sales team will have limited resources (e.g., sales people) to be assigned to sales leads. Accordingly, the effectiveness of the sales team will frequently depend upon how intelligently the limited resources are allocated to call on or engage sales leads, including new or potential company accounts as well as existing company accounts.

To effectively allocate the individual sales persons to call on or engage with sales leads, it is helpful to have some idea of the quality of the sales leads so that sales persons can be allocated to those sales leads that are most likely to result in a closed sale, or conversion. However, determining the quality of a sales lead is not trivial. In many instances, a particular person identified as a sales lead may have an interest in a product or service that the particular person's employer does not share. In other scenarios, the particular person identified as a sales lead may not have the desired decision making and purchasing power that is required to close a sale. These and other issues make it difficult to accurately identify and assess the quality of sales leads.

### DESCRIPTION OF THE DRAWINGS

Some embodiments are illustrated by way of example and not limitation in the FIGS. of the accompanying drawings, in which:

FIG. 1 is a block diagram illustrating various functional components of a buyer sentiment system with an account interest engine, consistent with some example embodiments, for use with a wide variety of applications, and specifically for determining the likelihood of a sales lead (e.g., an individual or organization) to purchase a product or service based on an interest score of a company account representing the sales lead and generated, at least in part, using individual interest scores of the members of the company account;

FIG. 2 is a block diagram of certain modules of an example system for determining the likelihood of a sales lead to make a purchase, consistent with some example embodiments;

FIG. 3 is a block diagram illustrating the flow of data that occurs when performing various portions of a method for determining the likelihood of a sales lead to make a purchase, consistent with some example embodiments;

FIG. 4 is a flow diagram illustrating method steps involved in a method for determining the likelihood of a sales lead to make a purchase, consistent with some example embodiments;

FIG. 5 is a block diagram of a machine in the example form of a computing device within which a set of instructions, for causing the machine to perform any one or more of the methodologies discussed herein, may be executed.

### DETAILED DESCRIPTION

The present disclosure describes methods, systems, and computer program products for determining the likelihood of an organization (e.g., a company) to purchase a product or service determined based on an interest score of a company account representing the organization that is generated using individual interest scores of the members of the organization. In the following description, for purposes of explanation, numerous specific details are set forth in order to provide a thorough understanding of the various aspects of different embodiments of the present invention. It will be evident, however, to one skilled in the art, that the present invention may be practiced without all of the specific details and/or with variations permutations and combinations of the various features and elements described herein.

The subject matter described herein may allow a buyer sentiment system (also “system”) to determine the purchasing propensity of an organization with regard to a particular product or service based on the levels of interest in the product or service of the individual members of the organization. Generally, a person identified as a sales lead is associated with an organization targeted as a potential purchaser of a product or service. For example, the association between a sales lead and an organization may be one of employment. In some instances, the sales lead may be the targeted organization itself.

Often, in the sales process, a sales lead may be represented by a company account identifier within a Customer Relationship Management (CRM) system. For example, a sales lead that is an organization targeted as a potential buyer may be represented by a company account identifier within another organization's CRM. For purposes of the present disclosure, the terms “company account” (hereinafter also “sales account” or “account”) is used broadly, and means an identification of an organization targeted as a potential purchaser of a product or service. Also, for the purposes of the present disclosure, the terms “account interest in a product or service” represent the inferred interest that the organization represented by the account has in purchasing the product or service. A “member of an account” (hereinafter also “member”) may be a person affiliated with or working for the organization represented by the account. In some example embodiments, the system may store data that pertains to accounts and members of the accounts as part of member profile data, social media data (e.g., social graph data), or account data maintained by a social networking service.

The system may allow a user (e.g., a salesperson) to evaluate the quality of a sales lead by providing the user with information pertaining to the purchasing propensity of an account representing the sales lead. The purchasing propensity of an account, in general, is the extent to which an organization represented by the account is open to consider purchasing a product or a service. The system may infer that an organization is highly interested in purchasing the product or service based on determining that, collectively, the persons known to be employed by the organization (i.e., the account members) have a high level of interest in the product or service. The account's propensity to purchase the product or service may be represented (e.g., measured) using an account interest score. The account interest score is, according to some example embodiments, calculated based on combining the individual interest scores of the members known to belong to the respective account. For example, an account may be “ready” to purchase (e.g., open or willing to consider purchasing) the product or service if one or more representatives of the organization identified as pertaining to the account may consider placing a purchase order for the product or service. Accordingly, the determination of a degree of interest in the product or service at the level of the account members serves as an indication of a degree of interest at the account level.

Upon determining the degree of interest in the product or service at the account level, the system may order (or rank) the available sales leads based on the determined account interest scores for the accounts representing the sales leads. As such, the sales leads may be prioritized for purposes of intelligent allocation of sales resources within the sales team.

Although identifying a decision maker affiliated with an account may be helpful during the sales process, knowing the identity of the decision maker may not be sufficient for obtaining an accurate evaluation of the degree of interest in a product or service within the organization represented by the account. For example, when the decision maker relies on one or more co-workers' input based on research, expertise, or experience, a deeper understanding of who in the particular organization is interested in a particular product or service, why, and to what extent may be helpful in determining the “temperature” of the particular account (e.g., where in the sales process or life cycle of a sale the account may be). By leveraging knowledge about the level of interest in the product or service exhibited by a plurality of members of the account, the system may better determine the buyer sentiment of the particular account (e.g., the likelihood that a sales call to the particular organization may convert to a closed sale).

The analysis of a portion of or the totality of the data about an account member may provide an insight into the member's affinity for the product or service. For example, by analysing certain behavioral data that pertains to the member, the system may identify member actions that signal or suggest the member's opinion of or intentions towards the product or service. For instance, members who are interested in the product or service are likely to seek out information pertaining to the product or service. They may, for example, respond to emails advertising the product or service, or download a whitepaper about the product or service. The system may infer that the more product- or service-connected activities a member engages in during a certain period of time, the higher the member's level of interest in the particular product or service during the particular period. Furthermore, by observing that a number of members of an account have engaged in a number of interest-manifesting activities during a pre-determined period of time, the system may infer an increased level of interest in the product or service within the organization represented by the account.

The system may provide a variety of services, applications, or content related to the product or service with which a member may interact. Member interactions with the services, applications, or items of content related to the product or service may be tracked and monitored to gather behavioral data of the account member. The behavioral data of the account member may be used to determine the buyer sentiment of the account to which the respective member pertains. The content related to the product or service may be available offline or online (including digital content). Examples of items of digital content related to the product or service may be a video, a movie, a blog, or an article. Accordingly, by monitoring the interactions of the members of a particular account with certain items of digital content (or other types of content), the system may identify signals of an increased collective level of interest associated with the account with respect to the product or service.

To gauge the buyer sentiment of an account for a particular product or service, the system calculates an account interest score for the particular product or service. In some example embodiments, the account interest score of an account indicates that the account is “ready” to buy the product or service when the account interest score exceeds a pre-determined buyer threshold score or when the account interest score ranks in a pre-determined percentage value of account interest scores. The respective account may be identified as a buying candidate and a salesperson may make sales call(s) to one or more members of the account.

The system may, in various example embodiments, calculate an account interest score for a particular sales account based on combining individual interest scores of the members of the particular sales account. In some example embodiments, the system infers (e.g., derives or computes) the individual interest score of a member of an account based on information gathered (e.g., by a machine) or available about the respective member. For example, a machine of the system may capture data that pertains to the member interacting with an application or service provided by the system. For example, when a member opens or responds to an email message that relates to a product or a service, the member's action(s) may be tracked and logged into a log file stored in a database of the system. Member interaction information may also be derived based on tracking, for example, when the email message was sent to a member, when the member opened (and read) the email message, and if and when the member responded to the email message. Further, the content and context of the member's response may be mined to extract information about the member's opinion about the product or service (e.g., positive, negative, or neutral), level of interest in the product or service, or likelihood of purchasing the product or service. An identifier of the product or service, a type of content with which the user interacted, and a time of interaction may be stored as attributes associated with an identifier of the user in a record included in a database. Other examples of member interactions with applications, services, or content that are provided by the system and that can be used to determine the member's level of interest in the product or service are selecting links on a web page or consuming content on a web site (e.g., tracked based on detecting content downloading activity by members or based on monitoring posts related to certain content).

Member interest in the product or service may be also detected based on the user engaging in offline activities (or content). Examples of items of offline activities are events, such as seminars, conferences, or meet-ups, which a person attends physically as opposed to online. The system may, for example, monitor registrations by members of an account to attend an offline seminar dedicated to a newly released product or service, as well as the actual attendance by the account members. Also, the system may supplement the behavioral data that the system already maintains for the account members with the data obtained for the account members in relation to the respective seminar (e.g., registration, attendance, leading a discussion, posing questions, requesting additional information, requesting to be contacted by persons affiliated with the seminar or with the newly released product or service, etc.)

In addition to the types of content with which the member interacts and the nature of interactions, the time, frequency and number of interactions during a pre-determined period are factors that may be considered during the determination of the member's individual interest score. If, for example, a member interacts often with an item of digital content (e.g., a blog that discusses a product or a service), then the system may infer that the member has a higher than average degree of interest in the product or service. Similarly, if a member engaged in a number of interactions with items of digital content recently (e.g., during the current month) and over a short period of time (e.g., during three consecutive days), the system may infer that the member has a higher than average degree of interest in the product or service. For example, the system may detect that a user registers for a webinar about a newly released product or service and, the next day, downloads a whitepaper about the newly released product or service and posts a comment on an article about the newly released product or service. Based on the user's three interactions with digital content within the span of two days, the system may determine that the user is highly interested in the newly released product or service. Thus, data gathered about a user interacting with one or more items of content at least a pre-determined number of times within a pre-determined period of time may be a factor in determining how interested in the product or service the user is.

However, a user's content interactions that occurred beyond a pre-determined period of time may be considered stale and not accurately reflecting the current level of the user's interest in the product or service. For example, if recent interactions are pre-determined to be those activities that occurred within the last month, a user's interaction with content two months prior to the date of the calculation of the user's individual interest score is considered to be stale. In some example embodiments, the data about the stale interactions may not be used by the system in determining the level of the user's individual interest in the product or service for the purpose of determining the current account interest score for the particular product or service. Accordingly, detecting an increased number of recent interactions by a member with content that relates to the product or service may indicate an increased individual level of interest in the product or service, and, possibly, an increased interest in the product or service at the account level.

The individual interest score may be determined based on the number of the member's interaction with one or more items of digital content related to the product or service during a pre-determined period. The item of digital content may relate to the product or service by, for example, showing, discussing, characterizing, promoting, or selling the product or service. Examples of items of digital content are a video, an audio piece, a web page, an electronic article, an email messages, a webinar, etc. Examples of a member interacting with an item of digital content are opening a web page or clicking on a link on a web page, watching or commenting on a video, opening or responding to an email message, registering or attending a webinar, etc. A member may interact with an email message (sent by the seller organization) a first time when he opens it (but does not respond to it) and a second time when he re-opens the email message and responds to it. Next, the user may interact with a website (of the seller) by registering to attend a webinar (advertised in the email message) and with the webinar when the user registers for and attends the webinar. Accordingly, the user's individual interest score may be based on the score assigned to each type of interaction (e.g., opening and reading the email message; re-opening, re-reading, and responding to the email message; visiting the website and registering for the webinar; and visiting the website and attending the webinar) and the number of times each type of activity occurred (e.g., reading the email message twice, responding to the email once, and visiting the website twice).

In some example embodiments, the system receives input data from a client computing device (e.g., a member's computer). The input data may include data about the member's interaction(s) with one or more items of digital content related to a product or service. Based on the input data, for each interaction by the user, the system identifies a type of interaction by the member with the item of digital content and an interaction score assigned to the type of interaction. The system also calculates an interaction count that identifies the number of times the user engaged in the particular type of interaction with the item of digital content during a pre-determined period of time. Then, the system generates the individual interest score of the member for the product or service based on the interaction score and the interaction count for one or more types of interactions with one or more items of digital content in which the user engaged. Alternately, or additionally, the individual interest scores may be determined based on the user's interaction with one or more items of offline content. An example of interacting with an item of offline content is registering for or attending a physical event (e.g., a live, non-online conference or seminar).

The individual interest scores may vary from one period of time to another based on a change in a member's level of interest in the product or service. Accordingly, a variation in one or more individual interest scores of the members of an account may lead to a change in the account interest score. Because the timing of a sales call may be important to the conversion of the sales call to a closed call, it may be beneficial to periodically re-evaluate an account's level of interest in the product or service such that the account interest score accurately reflects the buyer sentiment of the account at a particular time. Accordingly, the system may calculate the account interest score for the account at a pre-determined time (e.g., hourly, daily, weekly, or monthly) and determine whether the account interest score has changed since it was calculated last. Alternately or additionally, the detection of an increased interest by a member in a particular product or service may trigger a re-calculation of the account interest score of the account with which the member is affiliated. As such, the system may make a more accurate determination of the buyer sentiment of an account at a particular time.

By extracting and analysing the information about different account members' levels of interest in the product or service from data captured as a result of the members' interactions with different items of content, the system may infer a collective level of interest in the product or service within the organization represented by the account. More specifically, an account interest score that represents the target organization's collective level of interest in the particular product or service may be determined based on a combination of the individual interest scores that represent individual levels of interest in the respective product or service of all the known members of the account. The system may utilize one or more algorithms to combine the individual scores of the known members of an account to generate an account interest score for the account.

In certain example embodiments, the combination of the individual interest scores to compute the account interest score of an account includes aggregating the individual interest score of the known account members. Consistent with some example embodiments, the individual interest scores may be grouped into a plurality of groups according to different criteria (e.g., levels of individual interest, title or seniority, frequent recent interactions with a number of items of content by the members). Each grouping of individual interest scores may be assigned a different weight for purposes of calculating the account interest score. For example, a number of individual interest scores that correspond to members who have titles that indicate decision-making capacity may be grouped and assigned a heavier weight during the calculation of the account interest score. In certain example embodiments, different individual interest scores are not grouped but are assigned different weights in the determination of the account interest score.

In some example embodiments, the system receives an individual interest score of a user for a product or a service. Using account data that identifies the members of an account, the system assigns the individual interest score to a first group (of scores) based on the user being a member of the account and the individual interest score falling within a first range of individual interest scores. A range of individual interest scores may represent a level of interest in the product or service. There may be several ranges of individual interest scores to represent different levels of interest of different account members. For example, the individual interest scores of the members of an account may be grouped into the “low”, “medium”, and “high” levels of interest based on determining into which range of scores each individual interest score falls. This type of grouping may be helpful in determining account members who may be decision makers or influencers of decision makers. In some example embodiments, individual interest scores that exhibit a higher level of interest in the product or service may be given a bigger weight in the calculation of the account interest score. In certain example embodiments, the individual interest scores are grouped according to their level of interest (e.g., fall within a pre-determined range of individual interest scores) and, then, a weight is assigned to the aggregated group score. For example, the system may determine a first group weighted interest score based on aggregating the individual interest scores of the first group and assigning a first weight to a resulting first group aggregate score.

Similarly, the system may determine a second group (of individual interest scores) that includes individual interest scores that fall within a second range of individual interest scores. The second range may be different from the first range. The system also determines a second group weighted interest score based on aggregating individual interest scores of the second group and assigning a second weight to a resulting second group aggregate score. Then, the system calculates the account interest score for the account based on aggregating the first group weighted interest score with the second group weighted interest score.

In some example embodiments, the system identifies the account as a buying candidate based on determining that the account interest score exceeds a buyer threshold score. Alternately, or additionally, the system may rank the account interest scores of a number of accounts to determine which ones may be more receptive to receiving a sales pitch and possibly purchase the product or service. As a result of the ranking, a number of accounts or a top percentage of the total number of accounts may be identified as buyer candidates to receive sales calls.

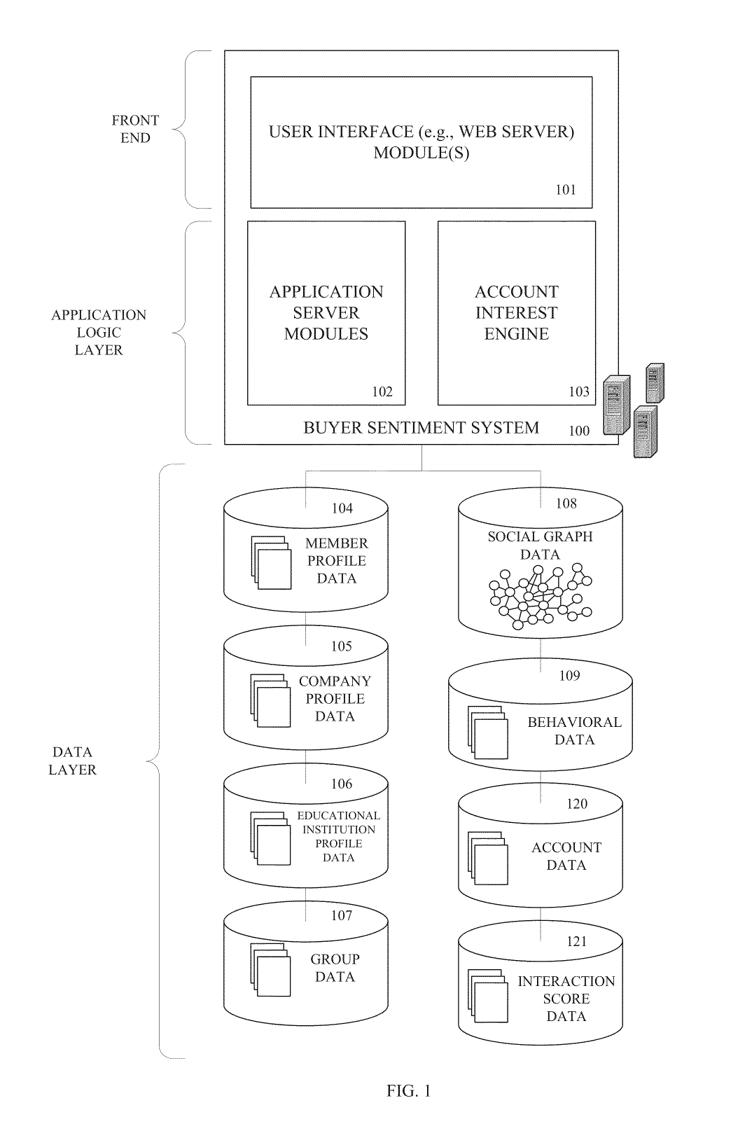

FIG. 1 is a block diagram illustrating various functional components of a buyer sentiment system 100 with an account interest engine 103, consistent with some example embodiments, for use with a wide variety of applications, and specifically for determining the likelihood of a sales lead to purchase a product or service based on an interest score of a company account related to the sales lead and generated using individual interest scores of the members of the company account. As shown in FIG. 1, the buyer sentiment system 100 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end consists of a user interface module (e.g., a web server) 101, which receives requests from various client-computing devices, and communicates appropriate responses to the requesting client devices. For example, the user interface module(s) 101 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer includes several databases, including databases for storing data for various functionalities of the buyer sentiment system 100, including member profiles 104, company profiles 105, educational institution profiles 106, as well as information concerning various online or offline groups 107. In addition, the buyer sentiment system 100 may utilize a graph data structure implemented with a social graph database 108, which is a particular type of database that uses graph structures with nodes, edges, and properties to represent and store data. Of course, with various alternative embodiments, any number of other entities might be included in the social graph, and as such, various other databases may be used to store data corresponding to other entities. Also, included is a behavioral database 109 for storing data pertaining to the behavior of various entities. For example, data that pertains to a user engaging with an item of digital content (e.g., downloading a song) may be stored in a record in the behavioral database 109. The record may be associated with and identified by a user identifier. In addition, an account database 120 that stores data about accounts and their members may be included in the data layer. Also, an interaction score database 121 that stores data about various types of interactions by account members with items of online and offline content may be included. The interaction score database 121 also may store an interaction score for each type of interaction.

With some example embodiments, the buyer sentiment system 100 may be integrated with a social network service and, thus, hosted by the same entity that operates the social network service. Consistent with some embodiments, when a person initially registers to become a member of the social network service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored, for example, in the database with reference number 104.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity, which may or may not be included in the social graph. Various types of relationships that may exist between different entities may be represented in the social graph data 108 that is stored, for example, in the database with reference number 108.

The social network service may provide a broad range of other applications and services that allow members the opportunity to share and receive information, often customized to the interests of the member. For example, with some embodiments, the social network service may include a photo sharing application that allows members to upload and share photos with other members. As such, at least with some embodiments, a photograph may be a property or entity included within a social graph. With some embodiments, members of a social network service may be able to self-organize into groups, or interest groups, organized around a subject matter or topic of interest. Accordingly, the data for a group may be stored in database 107. When a member joins a group, his or her membership in the group will be reflected in the social graph data stored in the database with reference number 108. With some embodiments, members may subscribe to or join groups affiliated with one or more companies. For instance, with some embodiments, members of the social network service may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of the database with reference number 108.

The application logic layer includes various application server modules 102, which, in conjunction with the user interface module(s) 101, generates various user interfaces (e.g., web pages) with data retrieved from various data sources in the data layer. With some embodiments, individual application server modules 102 are used to implement the functionality associated with various applications, services, and features of the buyer sentiment system 100. For instance, a messaging application, such as an email application, an instant messaging application, or some hybrid or variation of the two, may be implemented with one or more application server modules 102. Similarly, a search engine enabling users (e.g., salespersons) to search for and browse member profiles, company profiles, or account information may be implemented with one or more application server modules 102. Of course, other applications or services that utilize the account interest engine 103 may be separately embodied in their own application server modules 102.

In addition to the various application server modules 102, the application logic layer includes the account interest engine 103. As illustrated in FIG. 1, with some example embodiments, the account interest engine 103 is implemented as a service that operates in conjunction with various application server modules 102. For instance, any number of individual application server modules 102 can invoke the functionality of the account interest engine 103, to include an application server module associated with an application to utilize account interest score data. However, with various alternative embodiments, the account interest engine may be implemented as its own application server module such that it operates as a stand-alone application.

With some embodiments, the account interest engine 103 may include or have an associated publicly available application programming interface (API) that enables third-party applications to invoke the functionality of the account interest engine 103. While the applications and services that utilize (or leverage) the account interest engine 103 are generally associated with the operator of the buyer sentiment system 100, certain functionalities of the account interest engine 103 may be made available to third parties under special arrangements. For example, a third-party application may invoke the user-content interaction analysis functionality or the interest score generating functionality of the buyer sentiment system 100. Third parties may utilize various aspects of the buyer sentiment system 100 in conjunction with or separately from the social networking service that may be maintained by the operator of the buyer sentiment system 100. In some example embodiments, third-party applications may invoke the functionality of the account interest engine 103 using a “software as a service” (SaaS) or a stand-alone (turnkey or on-premise) solution.

Generally, the account interest engine 103 takes as input parameters individual interest scores of a plurality of users who interacted with one or more items of content (e.g., online, including digital, content or offline content). Using the input parameters, the account interest engine 103 analyses a portion or the entirety of the account data 120 to determine if any of the plurality of users belong to or are members of an account (e.g., work for the entity represented by the account). Once the account interest engine 103 determines that certain users are members of the same account, the account interest engine 103 generates an account interest score, using at least one computer processor, based on combining the individual interest scores of the users determined to belong to that account. The generating of the account interest score may be performed using one or more algorithms. Finally, the account interest engine 103 provides the account interest score to the application that invoked the account interest engine 103.

The account interest engine 103 may be invoked from a wide variety of applications. In the context of a messaging application (e.g., email application, instant messaging application, or some similar application), the account interest engine 103 may be invoked to provide a message sender (e.g., a salesperson) with an account interest score for a particular sales account targeted to receive a sales pitch. Similarly, the account interest engine 13 may be invoked to provide a salesperson with a visual representation of a comparison of various accounts' propensity to purchase the product or service at a particular time based on their account interest scores for the product or service.

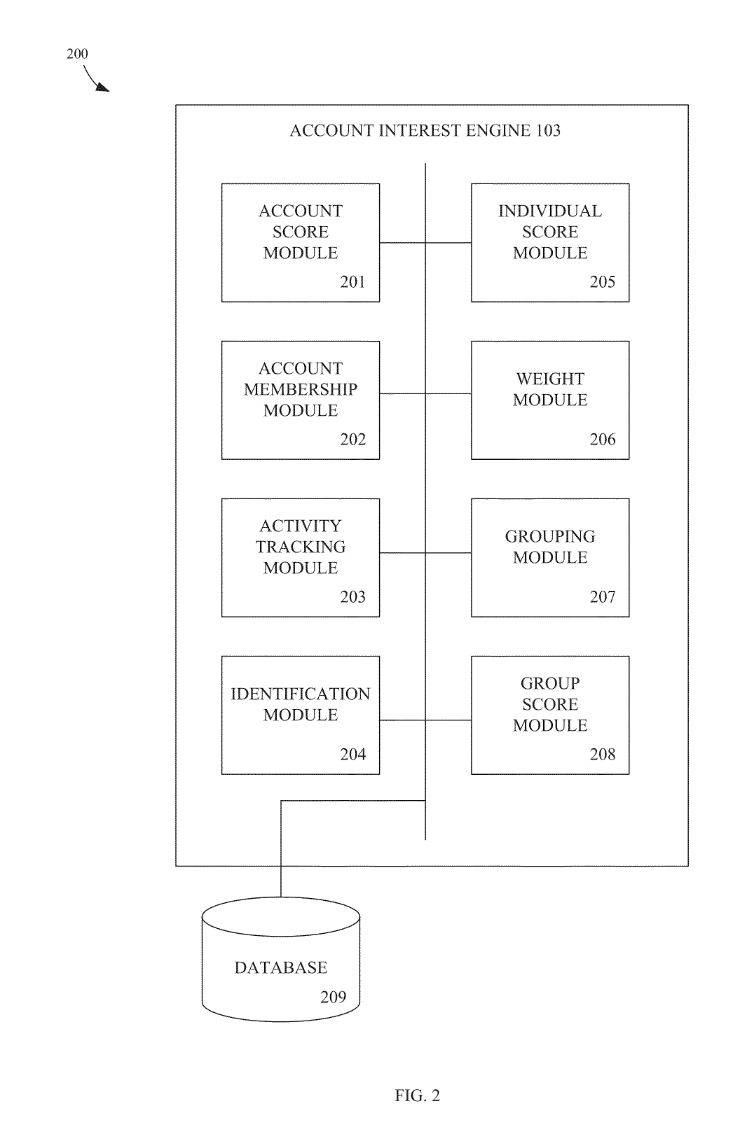

FIG. 2 is a block diagram of certain modules of an example system for determining the likelihood of a sales lead to make a purchase, consistent with some example embodiments. Some or all of the modules of system 200 illustrated in FIG. 2 may be part of the account interest engine 103. As such, system 200 is described by way of example with reference to FIG. 1.

The system 200 is shown to include a number of modules that may be in communication with each other. One or more modules of the system 200 may reside on a server, client, or other processing device. One or more modules of the system 200 may be implemented or executed using one or more hardware processors. In some example embodiments, one or more of the depicted modules are implemented on a server of the social networking system 100. In FIG. 2, the account engine 103 is shown as including an account score module 201, an account membership module 202, an activity tracking module 203, an identification module 204, an individual score module 205, a weight module 206, a grouping module 207, a group score module 208, and a database 209 configured to communicate with each other (e.g., via a bus, shared memory, or a switch).

The account score module 201 is configured to receive a first individual interest score of a first user for a product or a service. The account score module 201 is further configured to receive a second individual interest score of a second user for the product or service. The first and second individual interest scores may be received from an individual score module 205 discussed below. Based on a determination that the first user and the second user are members of the same account, the account score module 201, using at least one computer processor, generates an account interest score of the account for the product or service based on combining the first individual interest score of the first user and the second individual interest score of the second user. The generating of the account interest score may be performed at a pre-determined time (e.g., periodically). In certain example embodiments, the generating of the account interest score is performed in response to a triggering event, such as the detection of an increased interest in the product or service exhibited by one or more members of the account. A member's increased interest in the product or service may be determined, for example, based on data captured by the activity tracking module 203 discussed below.

In some example embodiments, the account score module 201 is further configured to identify the account as a buying candidate based on determining that the account interest score for the product or service exceeds a buyer threshold score. The account interest score of an account may be compared with a buyer threshold score to determine whether the buyer sentiment of the account is high and whether the account has a high propensity to purchase the respective product or service.

In certain example embodiments, the account score module 201 is further configured to identify the account as a buying candidate based on determining that the account interest score ranks in a pre-determined percentage of account interest scores. The account interest score of a particular account may be ranked against (compared to) the account interest scores of other accounts to determine whether the account falls within a particular percentile value of account interest scores. For instance, the system may select the top five percent of the accounts as buying candidates based on determining that these accounts have a high propensity to purchase the product or service and that a sales call to one of these top-ranking accounts is likely to convert to an actual sale of the product or service.

The account membership module 202 is configured to determine, using account data that identifies members of an account, that a first user and a second user are members of the same account. In some example embodiments, in addition to or instead of the account data 120, the account membership module 202 uses social graph data 108 that pertains to the members of the account and may be maintained by a social networking service. In some example embodiments, the determination of whether the first and second users are members of the account is made using data such as company profile data 105, member profile data 104, or group data 107 that may be stored in and retrieved from database 209. One or more records including associations (or affiliations) of accounts and users may be stored as account data 120 in, for example, database 209.

The account membership module 202 may also determine, using the account data, the levels of purchasing influence of the first user and the second user for the product or service within the account. For example, some members of the account, by virtue of their position within the organization represented by the account, their title, or their seniority, may have more influence with regards to purchasing decisions of certain products or services as compared to other members of the account. Using one or more algorithms that take as input parameters data, such as member profile data 104, social graph data 108, behavioral data 109, or company profile data 105, the account membership module 202 may derive a purchasing influence score for each member of an account. The level of purchasing influence (e.g., represented by a score) of a user may be determined based on information extracted from the account data 120, social graph data 108, company profile data 105, member profile data 104, group data 107, or behavioral data 109. The members' purchasing influence scores may be used, for example, to determine who may be a decision maker with regard to purchasing a particular product or service, or who should be targeted with a sales call when the system determines that the account is a buying candidate.

In some example embodiments, the account membership module 202 is further configured to determine one or more indicia of an account's propensity to purchase the product or service based on at least one of company profile data 105, social graph data 108, or behavioral data 109 maintained by a social networking service for the entity represented by the account. For example, an entity (e.g., a company) represented by the account may have a presence on a social network. News or social network updates that pertain to the entity represented by the account may be made public on behalf of the entity. Such news or updates may include information that is relevant to the buyer sentiment of the account for the product or service. Therefore, such news and updates may provide one or more indicia of the account's propensity to purchase the product or service that may be included in the process of deriving the account interest score of the account. Thus, the generating of the account interest score may be further based on the one or more indicia of the account's propensity to purchase the product or service. In some example embodiments, a weighted account interest score may be produced (e.g., by the weight module 206) by assigning a weight to the account interest score of the account based on the one or more indicia of the account's propensity to purchase the product or service.

The activity tracking module 203 is configured to receive input data that pertains to an interaction by the first user (and a second user) with an item of digital content. As discussed above, a user may interact with a variety of items of content, both online and offline. Included in the variety of items of online content may be items of digital content. For example, the activity tracking module 203 may capture data (e.g., using a cookie installed on the user's computer) related to the user's interactions with online content, such as the date and time the user opened an email or the Uniform Resource Locators (URLs) of web sites the user visited. Also, in another example, the activity tracking module 203 may detect when the user downloaded content from a particular web site of the operator of the system or registered for a webinar. The user's interaction with such exemplary items of digital content may be logged, analysed, and utilized to derive individual interest scores of users for the products or services related to these items of digital content.

The identification module 204 is configured to identify, based on the input data, a type of interaction by the first user with an item of digital content and the product or service to which the item of digital content relates. The identified type of interaction may be one of a plurality of types of interaction with items of content in which the users may engage. Similarly, the identification module 204 may identify, based on the input data, a type of interaction by the second user with an item of digital content and the product or service to which the item of digital content relates. The type of interaction by the first user with an item of digital content and the type of interaction by the second user with an item of digital content may or may not be the same. Similarly, the item of digital content with which the first user interacted may or may not be the same as the item of digital content with which the second user interacted. Examples of interactions by users with the items of digital content are opening an email message, responding to the email message, registering for a webinar, attending the webinar, downloading a whitepaper, etc.

The individual score module 205 is configured to receive an interaction score (e.g., from the interaction score database 121) for each type of interaction by the first user and an interaction count for each corresponding type of interaction by the first user. The interaction count that corresponds to a particular type of interaction by the first user identifies the number of times the first user engaged in the particular type of interaction with the item of digital content during a pre-determined period of time. Similarly, the individual score module 205 may receive an interaction score (e.g., from the interaction score database 121) for each type of interaction by the second user and an interaction count for each corresponding type of interaction by the second user. The interaction count that corresponds to a particular type of interaction by the second user identifies the number of times the second user engaged in the particular type of interaction with the item of digital content during a pre-determined period of time. A user interacting with an item of content multiple times may indicate an increased level of interest in the product or service. The individual score module 205 is further configured to generate the first individual interest score of the first user for the product or service based on one or more interaction scores and one or more interaction counts for one or more types of interaction by the first user. In some example embodiments, the individual interest score of a user may be derived by multiplying the interaction score for each type of content interaction in which the user engaged by the interaction count for the respective type of interaction by the user, and aggregating the resulting products. Similarly, the individual score module 205 may generate the second individual interest score of the second user for the product or service based on the interaction score and the interaction count for each of the one or more types of interactions with content by the second user.

For example, the system (e.g., the activity tracking module 203) may detect and log in a database the data pertaining to a user engaging with various types of online data. Such behavioral data may be the date and time the user accessed a web page, the type of web page content the user consumed (e.g., downloaded, looked at, or registered for) or recommended to another user, the product or service the web page content is related to, whether the user visited the web site multiple times over a pre-determined period of time, etc. Similarly, if a user received an email that relates to a product or service and responded to the email, data about the user's interactions with the email may be captured and stored for analysis or any other use by the system. This data may be retrieved from the database and used in one or more algorithms for calculating the user's individual interest score. In addition, the one or more algorithms for deriving the user's individual interest score may also use other data available for the user (e.g., social graph data 108, member profile data 104, or group data 107) that is informative of the user's interest in the product or service.

The weight module 206 is configured to produce a first weighted interaction score for the first user by assigning a first weight to an interaction score based on the type of interaction by the first user. For example, if a first member of an account reads and then recommends a blog entry to a second member of the account, then the recommending interaction may be assigned a heavier weight as compared to the weight assigned to a reading interaction not accompanied by a recommending interaction. In some example embodiments, the generating of the first individual interest score is based on the first weighted interaction score derived using the type of interaction by the first user.

The weight module 206 is further configured to produce a first weighted interaction score by assigning a first weight to the interaction score based on a type of item of digital content. The interaction with some types of items of content may be assigned a heavier weight as compared to interactions with other types of items of content. For example, a whitepaper (e.g., obtained online) may be assigned a heavier weight than a blog entry. In some example embodiments, the generating of the first individual interest score is based on the first weighted interaction score derived using the type of item of content consumed by the first user.

In certain example embodiments, the account membership module 202 determines the level of purchasing influence of the first user for the product or service within the account based on information extracted from the account data 120 or social graph data 108 maintained by a social networking service. The level of purchasing influence of the first user, in some instances, may also be determined relative to other members of the account. The weight module 206 produces a first weighted individual interest score for the first user by assigning a first weight to the first individual interest score based on the level of purchasing influence of the first user. Then, the account score module 201 generates the account interest score based on the first weighted individual interest score derived using the first user's level of purchasing influence.

Similarly, based on a second user being a member of the same account as the first user, the account membership module 202 may determine the level of purchasing influence of the second user for the product or service within the account. Once the second user's level of purchasing influence is determined, the weight module 206 produces a second weighted individual interest score for the second user. Then, the account score module 201 generates the account interest score based on a combination (e.g., aggregation) of the first weighted individual interest score and a second weighted individual interest score.

In some example embodiments, the weight module 206 is further configured to produce a first weighted individual interest score by assigning a first weight to the first individual interest score based on the seniority of the first user. The seniority of a user may be based on the number of years the user has filled a role in the organization, the number of years the user has been employed by an organization, or the total number of years the user has worked in a particular field of employment. The weight module 206 may also produce a second weighted individual interest score by assigning a second weight to the second individual interest score based on the seniority of the second user. In some example embodiments, the generating of the account interest score is based on aggregating the first weighted individual interest score derived using the first user's seniority and the second weighted individual interest score derived using the second user's seniority.

In certain example embodiments, the weight module 206 is further configured to produce a first weighted individual interest score by assigning a first weight to the first individual interest score based on the job title of the first user. The weight module 206 may also produce a second weighted individual interest score by assigning a second weight to the second individual interest score based on the job title of the second user. In certain example embodiments, the generating of the account interest score is based on aggregating the first weighted individual interest score derived using the first user's job title and the second weighted individual interest score derived using the second user's job title.

The grouping module 207 is configured to assign the first individual interest score to a first group of individual interest scores based on the first individual interest score falling within a first range of individual interest scores. The grouping module 207 is also configured to assign the second individual interest score to a second group of individual interest scores based on the second individual interest score falling within a second range of individual interest scores. The first range of individual interest scores is different from the second range of individual interest scores.

The group score module 208 is configured to determine a first group weighted score of the first group based on aggregating individual interest scores of the first group and based on assigning a first weight to a resulting first group aggregate score. The group score module 208 is also configured to determine a second group weighted score of the second group based on aggregating individual interest scores of the second group and based on assigning a second weight to a resulting second group aggregate score. In some example embodiments, the account score module 201 is further configured to determine the account interest score based on aggregating the first group weighted score with the second group weighted score.

In some example embodiments, the individual score module 205 is further configured to re-calculate the first individual interest score based on an indication of an increased interest of the first user in the product or service. The indication of an increased interest of the first user in the product or service may be identified by the individual score module 205 based on determining that a plurality of interactions by the first user with one or more items of digital content over a pre-determined period of time exceeds an interaction frequency threshold score. Once the individual score module 205 re-computes the first individual interest score to reflect the first user's increased interest in the product or service, the account score module 201 is further configured to re-generate the account interest score (e.g., compute a new account interest score for the account) based on the re-calculated first individual interest score.

Any two or more of these modules may be combined into a single module, and the functions described herein for a single module may be subdivided among multiple modules. Furthermore, according to certain example embodiments, the modules described herein as being implemented within a single machine, database, or device may be distributed across multiple machines, databases, or devices.

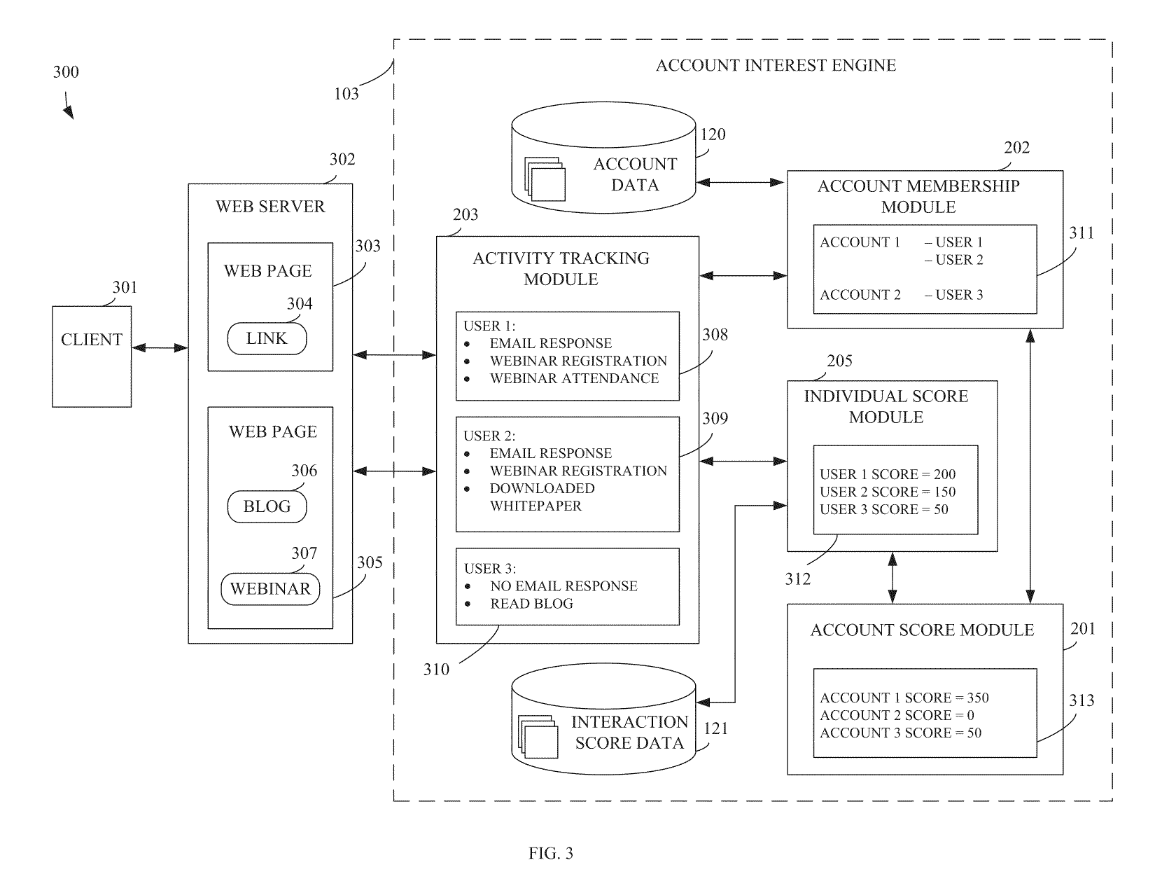

FIG. 3 is a block diagram illustrating the flow of data 300 that occurs when performing various portions of a method for determining the likelihood of a sales lead to make a purchase, consistent with some example embodiments.

In some example embodiments, a first user utilizes a client machine 301 to connect to web server 302 to view a web page 303, a web page 305, or both (e.g., rendered in a browser of the client machine 301), or engage in any other interaction with a variety of online content, as discussed above. A second user may utilize the client machine 301 or another client machine to view the web page 303, the web page 305, or both, or engage in any other user interaction with online content. For example, the first user, the second user, or both may select a link 304 (e.g., to download digital content) included in the web page 303; read, comment on, or recommend a blog 306 included on the web page 305; register or attend a webinar 307 included on the web page 305, or engage with any other content available on the web pages 303 or 305.

One or more modules of the account interest engine 103 capture data pertaining to user interactions with items of content online and offline, and perform the functions described herein. In certain example embodiments, the activity tracking module 203, detects activity by users with respect to certain items of online content. The activity tracking module 203 may, for instance, keep track of whether and when the first user opened a marketing email message sent to his email address (e.g., using a cookie installed on the first user's computer). Similarly, the activity tracking module 203 may monitor communications between the client 301 and the web server 302 to detect with which items of content (e.g., the link 304, the blog 306, or the webinar 307) a particular user interacted. For example, user data 308 pertaining to the first user's interactions, user data 309 pertaining to the second user's interactions, and user data 310 pertaining to a third user's interactions with a variety of content items may be stored as behavioral data 109 in one or more databases. The activity tracking module 203 may also determine other attributes of the user interactions with items of content, such as the time of initiating the interaction, the duration of the interaction, the frequency of interactions over a pre-determined period of time, or how soon the user interacted with the item of content after the item of content is presented to the user. These attributes may also be included as part of behavioral data 109.

Once activity data has been captured for one or more users, the individual score module 205, using interaction score data 121 and interaction count data for each type of content interaction by each user, derives an individual interest score 312 for each of the one or more users. For example, using one or more algorithms that take as input parameters the interaction scores assigned to different types of items of content or different types of interactions with the items of content, the individual score module 205 computes the individual interest scores 312 for the first user, the second user, and the third user based on these users' types of interactions and number of interactions per type of interaction. In some example embodiments, an individual interest score 312 may be based on an interaction count that identifies the number of times a particular user engaged in a type of interaction with the item of digital content during a pre-determined period of time.

Using the user data 308, 309, or 310, the account interest engine 103 may identify the users who have exhibited an interest in the product or service related to the items of content with which the users engaged. These items of content may discuss or advertise the product or service. Alternately, these items of content may discuss solution(s) provided by the product or service. The account membership module 202 may receive as input parameters data identifying the interested users (from the activity tracking module 203 or from a database) and account data 120 that identifies the members of an account (from the account database 120). Using these input parameters, the account membership module 202 may identify account-user associations 311 that connect one or more users to a particular account. For example, the account membership module 202 may determine that the first user and the second user are members of a first account, and that the third user is a member of a second account.

The account score module 201 may utilize one or more algorithms to combine the individual scores of the known members of an account to generate an account interest score for the account. More specifically, the account score module 201, using at least one computer processor, may compute an account interest score for the account based on individual interest scores computed by the individual score module 205 and based on the account-user relationship data derived by the account membership module 202. For example, to generate the account interest score for a first account, the account score module 201 may receive, as input from the individual score module 205, the first individual interest score for the first user and the second individual interest score for the second user, and, as input from the account membership module 202, data that connects the first user and the second user to the first account. Then, the account score module 201 may, for example, aggregate the individual interest score of the first user and the individual interest score of the second user to generate the account interest score for the first account.

Any two or more of these modules may be combined into a single module. The functions described herein for a single module may be subdivided among multiple modules and the functions subdivided among multiple modules may be performed by a single module. Furthermore, according to certain example embodiments, the modules described herein as being implemented within a single machine, database, or device may be distributed across multiple machines, databases, or devices.

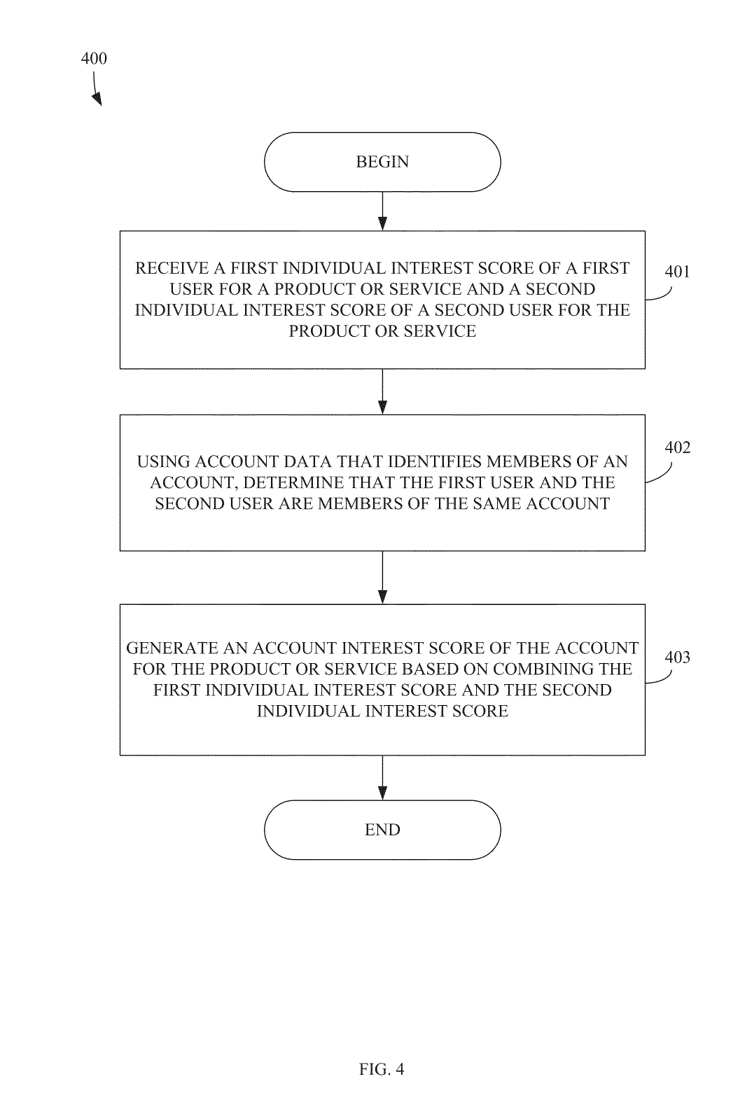

FIG. 4 is a flow diagram illustrating method steps involved in a method 400 for determining the likelihood of a sales lead to make a purchase, consistent with some example embodiments. The inventive subject matter can be implemented for use with applications that use any of a variety of network or computing models, to include web-based applications, client-server applications, or even peer-to-peer applications. As discussed above, in some example embodiments, the buyer sentiment system 100 may be integrated with a social network service and, thus, hosted by the same entity that operates the social network service. In certain example embodiments, the account interest engine 103 may be accessible (e.g., via an application programming interface, or API) to third-party applications that are hosted by entities other than the entity that operates the social network service.

Consistent with some example embodiments, the method begins at method operation 401, when the account score module 201 receives a first individual interest score of a first user for a product or a service and a second individual interest score of a second user for the product or service. With some example embodiments, the first and second individual interest scores are computed at a pre-determined time or periodically (e.g., hourly, daily, or weekly) to accurately reflect changes in the users' levels of interest in the product or service over the corresponding period of time. A user's individual interest score is computed based on input data that pertains to the user's interactions with items of online or offline content related to the product or service.

At method operation 402, the account membership module 202, using account data that identifies members of an account, determines that the first user and the second user are members of the same account. In some example embodiments, social graph data 108 that represents relationships and connections between various entities, including persons and companies, may also be used to determine whether certain users are members of the account (e.g., a company). For example, a user's membership in an account may represent an employment relationship between the user and the organization represented by the account.

Next, at method operation 403, the account score module 201, using at least one computer processor, generates an account interest score of the account for the product or service based on combining the first individual interest score and the second individual interest score. The method operation 403 may be performed periodically or in response to a triggering event, such as the detection of an increased interest by a member of the account in a particular product or service. For example, when the individual interest score module 205 identifies an indication of an increased interest of a user in the product or service, the individual interest score module 205 may re-compute the user's individual interest score to more accurately reflect his interest at that point in time. Then, the account score module 201 may generate a new account interest score for the account of which the user is a member based on the re-computed individual interest score of the user.

Alternately or additionally, the system may identify one or more indicia of an account's propensity to purchase the product or service based on any data available to the operator of the buyer sentiment system 100 for the entity (e.g., company) represented by the account. The account score module 201 may generate the account interest score based on the one or more indicia. For example, based on a public announcement by an organization, the system may analyse the public announcement data together with any other data available for the organization and identify one or more indicia of the organization having an increased interest in purchasing a particular product or service (or, generally, a product or service of a particular type or category). The system may then generate an account interest score for the particular organization relative to the particular product or service based on the one or more identified indicia. In some example embodiments, the account interest score is also based on the individual interest score(s) of the member(s) of the company account representing the particular organization.

The various operations of the example methods described herein may be performed, at least partially, by one or more processors that are temporarily configured (e.g., by software instructions) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

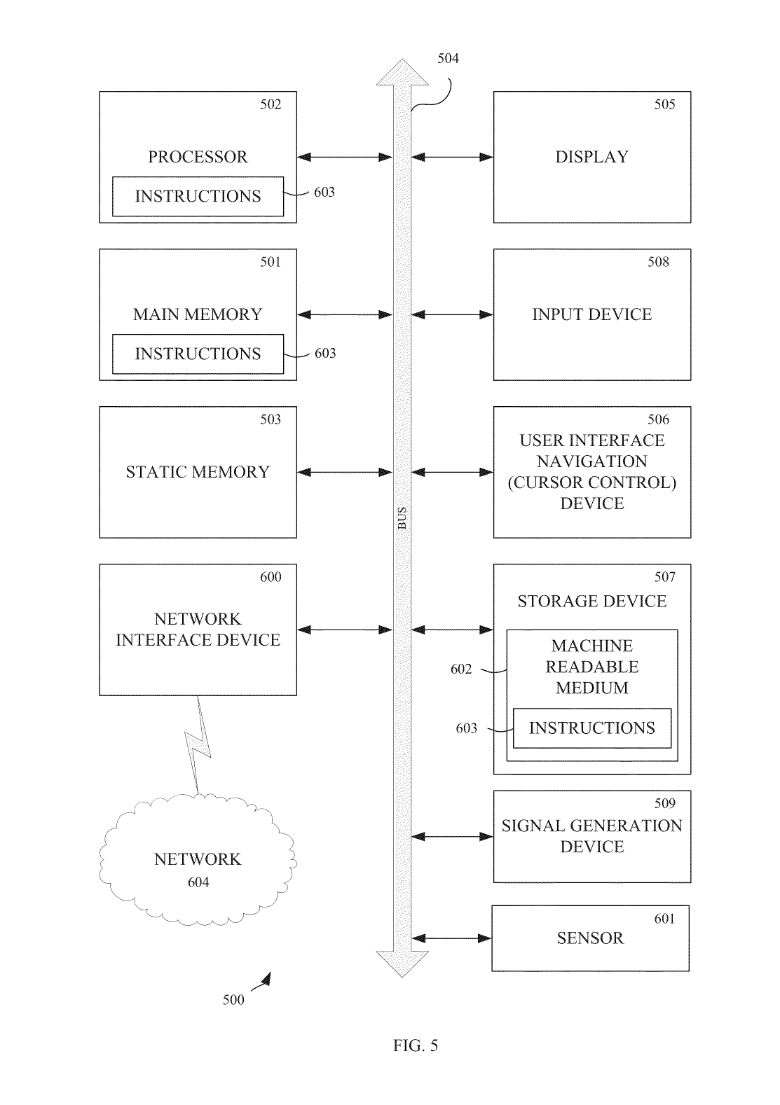

FIG. 5 is a block diagram of a machine in the example form of a computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 501, and a static memory 503, which communicate with each other via a bus 504. The computer system 500 may further include a display unit 505, an alphanumeric input device 508 (e.g., a keyboard), and a user interface (UI) navigation device 506 (e.g., a mouse). In some example embodiments, the display, input device, and cursor control device are a touch screen display. The computer system 500 may additionally include a storage device 507 (e.g., drive unit), a signal generation device 509 (e.g., a speaker), a network interface device 600, and one or more sensors 601, such as a global positioning system sensor, compass, accelerometer, or other sensor.

The drive unit 507 includes a machine-readable medium 602 on which is stored one or more sets of instructions and data structures (e.g., software 603) embodying or utilized by any one or more of the methodologies or functions described herein. The software 603 may also reside, completely or at least partially, within the main memory 501 and/or within the processor 502 during execution thereof by the computer system 500, the main memory 501 and the processor 502 also constituting machine-readable media.

While the machine-readable medium 602 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding, or carrying instructions for execution by the machine, and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 603 may further be transmitted or received over a communications network 604 using a transmission medium via the network interface device 600 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding, or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method for deriving an account interest score for a potential account of an organization, the method comprising:
for a product or service provided by the organization, receiving a first individual interest score of a first user and a second individual interest score of a second user;
using member-provided employment information included in member profile information of a social networking service, determining that the first user and the second user are both current employees of a company representing the potential account of the organization;
generating, using at least one computer processor, the account interest score for the potential account, for the product or service, based on combining the first individual interest score and the second individual interest score, the first individual interest score being weighted to reflect a seniority level of the first user and the second individual interest score being weighted to reflect the seniority level of the second user, the respective seniority levels derived based on information included in the respective member profiles of the first user and the second user as maintained by the social networking service; and
identifying the account as a lead based on determining that the account interest score exceeds some threshold.

2. The method of claim 1, wherein the receiving of the first individual interest score comprises:
receiving input data that pertains to an interaction by the first user with an item of digital content related to the product or service;
identifying, based on the input data, a type of interaction by the first user with the item of digital content, the type of interaction being one of a plurality of types of interaction;
receiving an interaction score for the type of interaction by the first user and an interaction count that identifies a number of times the first user engaged in the type of interaction with the item of digital content during a pre-determined period of time; and
generating the first individual interest score of the first user for the product or service based on one or more interaction scores and one or more interaction counts for one or more types of interaction by the first user, including the interaction score and the interaction count.

3. The method of claim 2, further comprising:
producing a first weighted interaction score by assigning a first weight to the interaction score based on the type of interaction by the first user; and wherein
the generating of the first individual interest score is based on the first weighted interaction score.

4. The method of claim 2, further comprising:
producing a first weighted interaction score by assigning a first weight to the interaction score based on a type of item of digital content; and wherein
the generating of the first individual interest score is based on the first weighted interaction score.

5. The method of claim 1, further comprising:
determining a level of purchasing influence of the first user for the product or service within the account based on information extracted from account data or the social graph data maintained by a social networking service;
producing a first weighted individual interest score by assigning a first weight to the first individual interest score based on the level of purchasing influence of the first user; and wherein
the generating of the account interest score is based on the first weighted individual interest score.

6. The method of claim 1, wherein the generating of the account interest score comprises:
assigning the first individual interest score to a first group of individual interest scores based on the first individual interest score falling within a first range of individual interest scores and the second individual interest score to a second group of individual interest scores based on the second individual interest score falling within a second range of individual interest scores, the second range being different from the first range;
determining a first group weighted score of the first group based on aggregating individual interest scores of the first group and assigning a first weight to a resulting first group aggregate score;
determining a second group weighted score of the second group based on aggregating individual interest scores of the second group and assigning a second weight to a resulting second group aggregate score; and
determining an account interest score based on aggregating the first group weighted score with the second group weighted score.

7. The method of claim 1, wherein
the first individual interest score being weighted based on assigning a first weight to the first individual interest score to reflect a seniority of the first user at the company representing the potential account of the organization; wherein
the second individual interest score being weighted based on assigning a second weight to the second individual interest score to reflect a seniority level of the second user at the company representing the potential account of the organization; and wherein
the generating of the account interest score is based on aggregating the first weighted individual interest score and the second weighted individual interest score.

8. The method of claim 1, further comprising:
producing a first weighted individual interest score by assigning a first weight to the first individual interest score based on a job title of the first user;
producing a second weighted individual interest score by assigning a second weight to the second individual interest score based on a job title of the second user; and wherein
the generating of the account interest score is based on aggregating the first weighted individual interest score and the second weighted individual interest score.

9. The method of claim 1, further comprising:
re-calculating the first individual interest score based on an indication of an increased interest of the first user in the product or service; and
re-generating the account interest score based on the re-calculated first individual interest score.

10. The method of claim 9, further comprising:
identifying the indication of an increased interest of the first user in the product or service based on determining that a plurality of interactions by the first user with one or more items of digital content related to the product or service over a pre-determined period of time exceeds an interaction frequency threshold score.

11. The method of claim 1, further comprising:
determining one or more indicia of an account's propensity to purchase the product or service based on at least one of company profile data, social graph data, or behavioral data maintained by a social networking service for the entity represented by the account; and
producing a weighted account interest score by assigning a weight to the account interest score based on the one or more indicia of the account's propensity to purchase the product or service.

12. The method of claim 1, further comprising:
identifying the account as a buying candidate based on determining that the account interest score exceeds a buyer threshold score.

13. (canceled)

14. A system for deriving an account interest score for a potential account of an organization, the system comprising:
a computer memory including a database; and
a server including at least one computer processor configured to implement:
an account membership module configured to determine, using member-provided employment information included in member profile information of a social networking service that a first user and a second user are both current employees of a company representing the potential account of the organization; and
an account score module configured to
receive, for a product or service provided by the organization, a first individual interest score of the first user and a second individual interest score of the second user,
generate the account interest score for the potential account, for the product or service, based on combining the first individual interest score and the second individual interest score, the first individual interest score being weighted to reflect a seniority level of the first user and the second individual interest score being weighted to reflect the seniority level of the second user, the respective seniority levels derived based on information included in the respective member profiles of the first user and the second user as maintained by the social networking service, and
identify the account as a lead based on determining that the account interest score exceeds some threshold.

15. The system of claim 14, further comprising:
an activity tracking module configured to receive input data that pertains to an interaction by the first user with an item of digital content related to the product or service;
an identification module configured to identify, based on the input data, a type of interaction by the first user with the item of digital content, the type of interaction being one of a plurality of types of interaction; and
an individual score module configured to
receive an interaction score for the type of interaction by the first user and an interaction count that identifies a number of times the first user engaged in the type of interaction with the item of digital content during a pre-determined period of time, and
generate the first individual interest score of the first user for the product or service based on one or more interaction scores and one or more interaction counts for one or more types of interaction by the first user, including the interaction score and the interaction count.

16. The system of claim 15, further comprising:
a weight module configured to produce a first weighted interaction score by assigning a first weight to the interaction score based on the type of interaction by the first user; and
wherein the generating of the first individual interest score is based on the first weighted interaction score.

17. The system of claim 15, further comprising:
a weight module configured to produce a first weighted interaction score by assigning a first weight to the interaction score based on a type of item of digital content; and
wherein the generating of the first individual interest score is based on the first weighted interaction score.

18. The system of claim 14, wherein
the account membership module is further configured to determine a level of purchasing influence of the first user for the product or service within the account based on information extracted from account data or the social graph data maintained by a social networking service; further comprising:
a weight module configured to produce a first weighted individual interest score by assigning a first weight to the first individual interest score based on the level of purchasing influence of the first user; and wherein
the generating of the account interest score is based on the first weighted individual interest score.

19. The system of claim 14, further comprising:
a grouping module configured to assign the first individual interest score to a first group of individual interest scores based on the first individual interest score falling within a first range of individual interest scores and the second individual interest score to a second group of individual interest scores based on the second individual interest score falling within a second range of individual interest scores, the second range being different from the first range;
a group score module configured to
determine a first group weighted score of the first group based on aggregating individual interest scores of the first group and assigning a first weight to a resulting first group aggregate score and
determine a second group weighted score of the second group based on aggregating individual interest scores of the second group and assigning a second weight to a resulting second group aggregate score; and wherein
the account score module is further configured to determine the account interest score based on aggregating the first group weighted score with the second group weighted score.

20. The system of claim 14, wherein
the weight module is further configured to
weight the first individual interest score based on assigning a first weight to the first individual interest score to reflect a seniority of the first user at the company representing the potential account of the organization and
weight the second individual interest score based on assigning a second weight to the second individual interest score to reflect a seniority of the second user at the company representing the potential account of the organization; and
the generating of the account interest score is based on aggregating the first weighted individual interest score and the second weighted individual interest score.

21. The system of claim 14, wherein
the weight module is further configured to
produce a first weighted individual interest score by assigning a first weight to the first individual interest score based on a job title of the first user and
produce a second weighted individual interest score by assigning a second weight to the second individual interest score based on a job title of the second user; and
the generating of the account interest score is based on aggregating the first weighted individual interest score and the second weighted individual interest score.

22. The system of claim 14, wherein
the individual score module is further configured to re-calculate the first individual interest score based on an indication of an increased interest of the first user in the product or service; and
the account score module is further configured to re-generate the account interest score based on the re-calculated first individual interest score.

23. The system of claim 22, wherein
the individual score module is further configured to identify the indication of an increased interest of the first user in the product or service based on determining that a plurality of interactions by the first user with one or more items of digital content related to the product or service over a pre-determined period of time exceeds an interaction frequency threshold score.

24. The system of claim 14, wherein
the account membership module is further configured to determine one or more indicia of an account's propensity to purchase the product or service based on at least one of company profile data, social graph data, or behavioral data maintained by a social networking service for the entity represented by the account; and
the weight module is further configured to produce a weighted account interest score by assigning a weight to the account interest score based on the one or more indicia of the account's propensity to purchase the product or service.

25. The system of claim 14, wherein
the account score module is further configured to identify the account as a buying candidate based on determining that the account interest score exceeds a buyer threshold score.

26. (canceled)

27. A non-transitory machine-readable medium for deriving an account interest score for a potential account of an organization, the non-transitory machine-readable medium comprising instructions, which when implemented by one or more processors, perform the following operations:
for a product or service provided by the organization, receiving a first individual interest score of a first user and a second individual interest score of a second user;
using member-provided employment information included in member profile information of a social networking service, determining that the first user and the second user are both current employees of a company representing the potential account of the organization;
generating the account interest score for the potential account, for the product or service, based on combining the first individual interest score and the second individual interest score, the first individual interest score being weighted to reflect a seniority level of the first user and the second individual interest score being weighted to reflect the seniority level of the second user, the respective seniority levels derived based on information included in the respective member profiles of the first user and the second user as maintained by the social networking service; and
identifying the account as a lead based on determining that the account interest score exceeds some threshold.
